(19) United States
(12) Patent Application Publication
(10) Pub. No.: US 2015/0022495 A1
(43) Pub. Date: Jan. 22, 2015

(54) Multi-Sensor Chip

(71) Applicant: Apple Inc., Cupertino, CA (US)

(72) Inventors: Jean-Marie Bussat, Cupertino, CA (US); Benjamin B. Lyon, Cupertino, CA (US); Scott A. Myers, Cupertino, CA (US); Terry L. Gilton, Boise, ID (US)

(21) Appl. No.: 14/335,553

(22) Filed: Jul. 18, 2014

Related U.S. Application Data
(60) Provisional application No. 61/856,193, filed on Jul. 19, 2013.

(51) Int. Cl. G06F 3/041; G06F 3/042; B32B 38/10; G06F 3/044

(52) U.S. Cl. CPC G06F 3/041; G06F 3/044; G06F 3/042; B32B 38/10; G06F 2203/04103; G06F 2203/04106; B32B 2307/412; B32B 2457/208
USPC 345/174; 345/173; 345/175; 156/222

(57) ABSTRACT

Embodiments of the present disclosure are directed to a sensor without a traditional substrate. In the disclosed embodiments, a substrate may be omitted and the sensor may be mounted on, and/or incorporated into, a functional element of an electronic device such as a cover glass for a touch screen or a display of a computing device. As a substrate may be used during formation of the sensor, the substrate on which the sensor is actually mounted on during use can be configured to have certain properties or characteristics, such as transparency, a certain thickness, and the like. In other words, the parameters of the substrate used to mount the sensor may not be constrained by the requirements of the manufacturing process of the sensor.

### CROSS-REFERENCE TO RELATED APPLICATION

This application claims the benefit under 35 U.S.C. §119(e) to U.S. Provisional Patent Application No. 61/856,193, filed on Jul. 19, 2013, entitled “Multi-Sensor Chip,” the contents of which are incorporated by reference as if fully disclosed herein.

### TECHNICAL FIELD

The present invention relates generally to electronic devices, and more specifically, to sensors for electronic devices.

### BACKGROUND

Many devices use sensors to detect one or more characteristics or parameters. For example, many touch-screen electronic devices may include capacitive sensors (and/or alternative sensors) that may detect a user's touching the screen of the device, and register this as an input. Often, some sensors may require one or more components to be mounted on a substrate, such as silicon. This substrate may be opaque and, thus, the sensor substrate may be visible through portions of the electronic device if it is so positioned. For example, capacitive imaging sensors are typically manufactured using complementary metal—oxide—semiconductor (CMOS) process on a silicon substrate. Because the silicon is not transparent to light, the sensor often is positioned on areas of the electronic device that are not used to display visual information, or beneath such areas.

Additionally, the opaque nature of the sensor substrate may prevent other sensors from being stacked beneath the first sensor, which may limit the number of parameters sensed for a particular input and/or limit the amount of data that may be collected. Moreover, the substrate for the sensor may introduce additional thickness to the device that may increase the overall thickness of the device.

### SUMMARY

Examples of the disclosure may include an electronic device. The electronic device includes a processor and a sensing element in communication with the processor. The sensing element includes a first sensor and a second sensor, where first sensor and the second sensor are vertically aligned. Additionally, at least one of the first sensor and the second sensor is transparent.

Other examples of the disclosure include a method for creating a sensor chip. The method includes creating a first sensor configured to sense a first parameter, the first sensor having a first original thickness, bonding a carrier wafer to a first side of the first sensor, reducing the first original thickness of the first sensor to a first thinned thickness, and bonding a second sensor configured to sense a second parameter to the first sensor, the second sensor having a second original thickness.

Yet other examples of the disclosure include a method for creating a sensing element for a computing device. The method includes creating a transparent sensor chip configured to sense two types of inputs and attaching the transparent sensor chip to a substrate.

### BRIEF DESCRIPTION OF THE DRAWINGS

FIG. 1A is a front perspective view of an electronic device including a sensing element.

FIG. 1B is a simplified block diagram of the electronic device of FIG. 1A.

FIG. 2A is a simplified diagram of the sensing element of FIG. 1A.

FIG. 2B is a simplified diagram of the sensing element of FIG. 2A connected to a substrate.

FIG. 2C is a simplified diagram of the sensing element including a single sensor attached to a substrate.

FIG. 3 is a flow chart illustrating a method for creating the sensing element.

FIG. 4A is a simplified cross-section view of a first sensor having an initial thickness attached to a substrate or carrier.

FIG. 4B is a simplified cross-section view of the first sensor with a thinned or reduced thickness after a thinning operation.

FIG. 4C is a simplified cross-section view of the first sensor and the substrate connected to a second sensor having an initial thickness.

FIG. 4D is a simplified cross-section view of the first sensor, the substrate, and the second sensor with the second sensor having a thinned or reduced thickness after a thinning operation.

FIG. 5 is a simplified cross-section view of the electronic device taken along line 5-5 in FIG. 1A illustrating the sensing element incorporated into an input button of the electronic device.

FIG. 6 is a simplified cross-section view of the sensing element illustrated in FIG. 5 with a user applying an input to the substrate.

FIG. 7A is a diagram of data captured by a first sensor in the sensing element during the user input shown in FIG. 6.

FIG. 7B is an image of data captured by a second sensor in the sensing element during the user input shown in FIG. 6.

FIG. 8 is a simplified cross-section view of the electronic device taken along line 8-8 in FIG. 1A illustrating the sensing element incorporated into a camera of the electronic device.

FIG. 9 is a simplified cross-section view of the electronic device taken along line 9-9 in FIG. 1A illustrating the sensing element incorporated into a display of the electronic device.

### DETAILED DESCRIPTION

The disclosure may take the form of a method for creating a sensor without a traditional, separate substrate to which the sensor is attached. Rather, such a substrate may be omitted and the sensor may be mounted on, and/or incorporated into, a functional element of the device. As an example, the sensor may be mounted on a cover glass for a touch screen or other display of a computing device. Additionally, because the substrate used during formation of the sensor may be omitted or removed after processing, the substrate on which the sensor is actually mounted on during use can be configured to have certain properties or characteristics, such as transparency, a certain thickness, and the like. In other words, the parameters of the substrate used to mount the sensor may not be constrained by the requirements of the manufacturing process of the sensor.

Additionally, the method may include operations for connecting two or more sensors together, thereby forming a sensor stack. This may allow two or more sensors to detect data or parameters through the same stack (e.g., vertical location). For example, a bottom sensor may detect one or more optical properties although an upper or top sensor is positioned atop it. As one specific example, the top sensor may detect changes in capacitance (for example, function as a touch sensor, or a fingerprint sensor) and the bottom sensor may detect optical light wavelengths (e.g., function as an image sensor). Likewise, another embodiment may include one sensor for capacitive fingerprint sensing, and a second sensor operative to sense force. As another example, the top sensor may detect a first type of optical parameter, such as visible light, and a second sensor may detect a second type of optical parameter, such as a infrared light.

The method may include creating or manufacturing a first sensor wafer. The first sensor wafer may be constructed based on the desired properties of the sensor. Once the first sensor wafer is constructed, a second wafer or carrier wafer is bonded to the first sensor wafer. Once bonded together, the wafer stack may be processed and one or both of the wafers may be thinned or otherwise reduced in thickness. For example, the first sensor wafer may be background and/or polished to thin the wafer. Often, the first sensor wafer may be sufficiently thinned to be substantially (if not completely) transparent. In some embodiments, and depending on the material making up the sensor, this may mean that the sensor wafer is equal to or less than 1 micron thick. Continuing with this example, the carrier wafer may not be thinned, such that the wafer stack may be able to be handled, despite the reduction in thickness of the first sensor stack. In another example, both the first sensor wafer and the carrier wafer may be thinned; however, one of the wafers may be thinned further than the other.

In some embodiments, after the first sensor wafer has been thinned, a second sensor wafer may be connected to the first sensor wafer. Once connected, the second sensor wafer may also be thinned. The first and second wafers may be mounted on a permanent substrate or mounting substrate and the carrier wafer may be removed (e.g., using solvents, grinding, etching and the like). In these embodiments, the carrier wafer may function as a processing substrate that provides structural support for the first and/or second wafer stacks during manufacturing, but is removed prior to the sensor stack being implemented in a device or component. This allows the permanent substrate to be selected based on desired characteristics or properties that may be separate from the requirements of the substrate during manufacturing.

In other embodiments, the carrier wafer may remain attached to the sensor stack and may provide certain functions for the sensor stack. For example, the carrier wafer may be an active wafer including logic and/or mixed signal circuitry that may be connected to one or both of the sensor wafers. Additionally, in some embodiments, the carrier wafer may be transparent or partially transparent, which may allow light to be transmitted therethrough.

As generally discussed above, the sensor chip may include a transparent sensor and/or substrate. The sensor may be incorporated into a number of different components of an electronic device. For example, the sensor can be incorporated into a display, camera, and/or input button for the electronic device. As a specific example, the sensor chip may include a very thin crystalline silicon layer positioned above a visual display. The silicon layer may be sufficiently thin to be transparent or substantially transparent. The sensor can be modulated electrically, grounded, allowed to float, or held at a particular potential. As one example, the main area of the sensor can include the sensing array (such as a capacitive imaging array) and any remaining additional circuit elements, such as transistors and the like, may surround the sensing array around the edges, which may allow the sensing array to be at least partially transparent.

In yet other examples, the sensor chip may be completely transparent. For example, the sensor chip may include a sensor layer or wafer where, during manufacturing, excess material is removed and the sensing elements, such as electrodes for detecting changes in capacitance, may form the entire structure of the sensor. In these embodiments, the sensor may be connected to control electronics, such as drive/sense lines in the capacitance sensing example, from an outside area of the sensor or of a display. In these embodiments, a third wafer or substrate, which may be transparent, may be connected to the sensing elements of the sensor, which eliminates the need for any remaining silicon on the edges of the sensing array.

### DETAILED DESCRIPTION

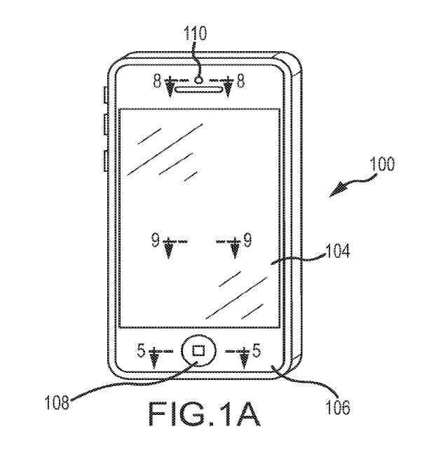

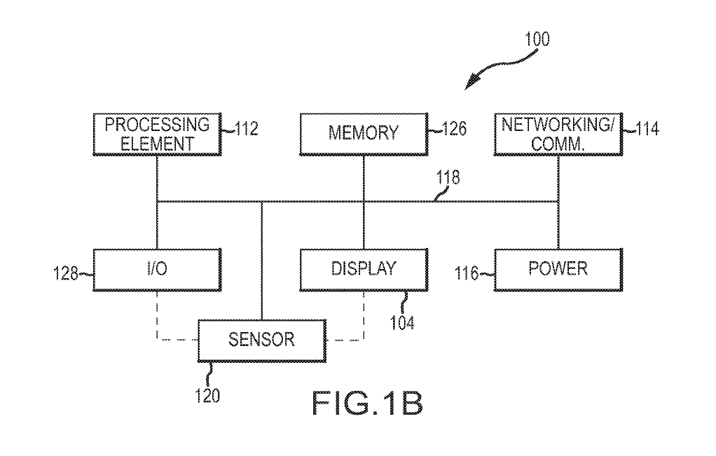

Turning now to the figures, a sensor chip and an illustrative electronic device for incorporating the sensor chip be discussed in more detail. FIG. 1A is a front elevation view of an electronic device 100 including a sample sensor chip. FIG. 1B is a simplified block diagram of the electronic device. The electronic device 100 may include a display 104, an enclosure 106, one or more input and/or output members 108, and a camera 110. It should be noted that the electronic device 100 may include a plurality of other components, such as a speaker, one or more ports (e.g., charging port, data transfer port, or the like), additional input/output buttons, and so on. As such, the discussion of any electronic device is meant as illustrative only. The electronic device 100 may be substantially any type of device incorporating a sensor or sensing element. Some examples of electronic devices may include a computer, laptop, tablet, smart phone, digital camera, printer, scanner, copier, glasses, other portable wearable devices, media players, security systems or devices, automobiles or electronics for automobiles, and so on.

The display 104 may be operably connected to the electronic device 100 or may be communicatively coupled thereto (e.g., a standalone monitor in communication with a computer). The display 104 may provide a visual output for the electronic device 100 and/or may function to receive user inputs to the electronic device 100. For example, the display 104 may be a multi-touch capacitive sensing screen that may detect one or more user inputs. An example of the display will be discussed in more detail below with respect to FIG. 9.

With reference to FIGS. 1A and 1B, the enclosure 106 may form an outer surface or partial outer surface and protective case for the internal components of the electronic device 100 and may at least partially surround the display 104. The enclosure 106 may be formed of one or more components operably connected together, such as a front piece and a back piece, or may be formed of a single piece operably connected to the display 104.

The input member 108 (which may be a switch, button, capacitive sensor, or other input mechanism) allows a user to interact with the electronic device 100. For example, the input member 108 may be a button or switch to alter the volume, return to a home screen, or the like. The electronic device 100 may include one or more input members 108 and/or output members, and each member may have a single input or output function or multiple input/output functions. In some embodiments, the input member may include output functionality in addition to the input capabilities. As a specific example, the input member 108 may include one or more mechanisms for providing haptic feedback.

With reference to FIG. 1B, the electronic device 100 may also include a number of active components that may be received within the enclosure 106 or otherwise hidden from a user. The electronic device 100 may also include one or more processing elements 112, a storage or memory component 126, an input/output interface 128, a power source 116, and one or more sensors 120, each will be discussed in turn below.

The processor or processing element 112 may control one or more functions and/or operations of the electronic device 100. The processing element 112 may be in communication, either directly or indirectly, with substantially all of the components of the electronic device 100. For example, one or more system buses 118 or other communication mechanisms may provide communication between the processing element 112, the camera 110, the display 104, the input member 108, the sensors 120, and so on. The processing element 112 may be any electronic device cable of processing, receiving, and/or transmitting instructions. For example, the processing element 112 may be a microprocessor or a microcomputer. As described herein, the terms “processor” and “processor element” are meant to encompass a single processor or processing unit, multiple processors, or multiple processing units, or other suitably configured computing element.

The memory 126 may include one or more storage or memory components that store electronic data that may be utilized by the electronic device 100. For example, the memory 126 can store electrical data or content e.g., audio files, video files, document files, and so on, corresponding to various applications. The memory 126 may be, for example, non-volatile storage, a magnetic storage medium, optical storage medium, magneto-optical storage medium, read only memory, random access memory, erasable programmable memory, or flash memory.

The network/communication interface 114 may provide connection to one or more connection or networking systems for the electronic device 100 and/or facilitate transmission of data to a user or to other electronic devices. For example, the network/communication interface 114 may transmit data between the electronic device 100 and one or more networks (e.g., WiFi, Ethernet, Bluetooth), cellular networks, and so on. The type of communication network may depend on a variety of different requirements, design parameters, and so on, and as such the network/communication interface 114 may be modified as desired. In embodiments where the electronic device 100 is a phone, the network/communication interface 114 may be used to receive data from a network, or may be used to send and transmit electronic signals via a wireless or wired connection (Internet, WiFi, Bluetooth, and Ethernet being a few examples). In some embodiments, the network/communication interface 114 may support multiple network or communication mechanisms. For example, the network/communication interface 114 may pair with another device over a Bluetooth network to transfer signals to the other device, while simultaneously receiving data from a WiFi or other network.

The input/output interface 118 may receive data from a user or one or more other electronic devices. For example, the input/output interface 118 may determine user inputs to a touch-screen display or element, as well as user inputs to the one or more input members 108. Additionally, the input/output interface 118 may determine or facilitate output to one or more output devices, such as speakers, haptic devices, headphones, and the like.

The power source 116 may be substantially any device capable of providing energy to the electronic device 100. For example, the power source 116 may be a battery, a connection cable that may be configured to connect the electronic device 100 to another power source such as a wall outlet, or the like.

In addition to the sensor chip 120, which will be discussed in more detail below, the electronic device 100 may include one or more other sensors that may be used to provide data to the electronic device. For example, the electronic device 100 may include one or more audio sensors (e.g., microphones), light sensors (e.g., ambient light sensors), gyroscopes, accelerometers, or the like. The sensors may be used to provide data to the processing element 112, which may be used to enhance or vary functions of the electronic device 100.

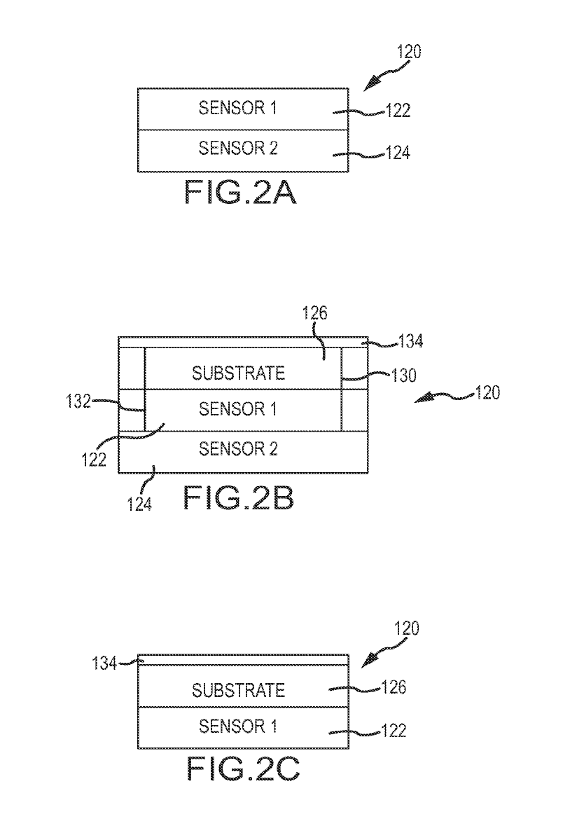

The sensor chip 120 will now be discussed in further detail. FIGS. 2A-2C illustrate block diagrams of examples of the sensor chip 120. The sensor chip 120 may be incorporated into a variety of different components within the electronic device 100 and/or may be used on its own to sense one or more characteristics or data. Some embodiments of the sensor chip 120 may include one or more sensors. For example and as shown in FIGS. 2A and 2B, the sensor chip 120 may have two sensors; however, it should be noted that the techniques and devices described herein may be used to create a sensor stack with one sensor, such as the sensor chip shown in FIG. 2C, or a sensor stack/chip with three or more sensors by iterating the processes described herein.

With reference first to FIG. 2A, the sensor 120 may include a first sensor 122 and a second sensor 124. The two sensors 122, 124 may be stacked vertically relative to one another, such that the two sensors 122, 124 may be aligned with one another and with a top surface of the second sensor 124 being stacked against a bottom surface of the first sensor 122. The two sensors 122, 124 may be formed in wafers or layers that are formed and bonded together. The sensors 122, 124 may be substantially any type of sensing element that may sense one or more parameters or data. As some illustrative examples, one or both of the sensors 122, 124 may be an image sensor including one or more light sensing elements, infrared sensor, capacitive sensor, ultrasonic sensor, micro-electromechanical systems (MEMS), accelerometers, or the like. As one specific example, the first sensor 122 may be a capacitive sensor and the second sensor 124 may be an image sensor.

Although one or both of the sensors 122, 124 may sense one or more optical characteristics, the sensors 122, 124 may be stacked on top of another because one or both of the sensors 122, 124 may be substantially transparent. For example, the first sensor 122 may be a capacitive sensor and may be substantially transparent and the second sensor 124 may be an optical sensor and may sense optical characteristics after light waves have been transmitted through the first sensor 122. Because one or both of the sensors 122, 124 may be transparent (or include transparent elements), the sensor chip 120 may sense two or more characteristics from a single input (e.g., a capacitive characteristics as well as an optical image). One or both of the sensors 122, 124 may include bond pads 146 that provide electrical communication to the sensing array or sensing elements within the sensors 122, 124. The bond pads 146 may be a transparent material such as indium tin oxide (ITO) or an opaque or non-transparent material that may be sufficiently thin to be substantially transparent.

As shown in FIG. 2A, the sensor chip 120 does not include a substrate or support. In these embodiments the sensor chip 120 may be manufactured with a carrier or temporary substrate that may be removed prior to the sensor chip 120 being implemented into the electronic device 100. In these embodiments, one or more components of the electronic device 100 may function as the substrate for the sensor chip 120, which may reduce the overall thickness of the component incorporating the sensor chip 120.

With reference to FIG. 2B, in some embodiments, the sensor chip 120 may include a substrate 126. The substrate 126 may provide support for the sensor chip 120 and allow the sensor chip 120 to be mounted on a variety of different components within the electronic device 100. Additionally, the substrate 126 may be an active wafer and include logic and signal circuitry that may communicatively couple the sensors 122, 124 to one or more components of the electronic device 100 (e.g., one or more processing elements 112). For example, the substrate 126 may include one or more through silicon vias (TSVs) or bond pad connections. In these embodiments, the substrate 126 may include interconnects formed thereon, such as traces formed into the substrate. As one example, the substrate may be glass including ITO traces positioned thereon, which may maintain the transparency of the substrate.

The substrate 126 may be a transparent material or may be sufficiently thinned or have a sufficiently thin thickness to be essentially transparent. As some examples, the substrate 126 may be glass, sapphire, silicon, thermoplastic material, or the like.

Alternatively or additionally, as shown in FIG. 2A, the substrate 126 may form a temporary support for the sensor chip 120 and may be removed after manufacturing, which will be discussed in more detail below. In these embodiments, the substrate 126 may function as a carrier wafer to carrier the sensor stack 122, 124 during manufacturing. Because the substrate may be removed, the material forming the substrate may not be transparent. As some examples, a temporary substrate may include an adhesive such as tape that may be removed after the sensors 122, 124 are stacked together and/or the sensor chip is connected to a permanent substrate or a silicon or other material that may be etched away or removed using solvents.

In instances where the sensor chip includes a temporary substrate during manufacturing, after manufacturing the sensor chip 120 can be mounted on a component of the electronic device 100 that may function as a mounting substrate 126. For example, the sensor chip 120 may be mounted to the cover glass of the display 104 or a lens of the camera 110. As another example, the sensor chip 120 may be mounted to an encapsulation glass for an organic light emitting diode (OLED).

The sensor chip 120 may be connected to a variety of different components having different material properties that may function as a support or substrate for the sensor stack. As discussed herein the substrate 126 may refer to any substrate used during or after manufacturing of the sensor chip 120. For example, the substrate 126 may be the carrier substrate used during processing but then later removed, the substrate 126 may be the carrier substrate that also forms a support substrate and/or active wafer after processing, and/or the substrate may represent the secondary or permanent substrate that may be attached to the sensor chip 120 after (or shortly before) the carrier substrate is removed. As such, as used herein the term substrate is meant to encompass both a carrier substrate or carrier wafer during manufacturing, a permanent or mounting substrate used to support the sensor chip in the electronic device, and a substrate that is used both during manufacturing and to support the sensor chip within the electronic device.

In yet other embodiments, the sensor chip 120 may include a single sensor 122 attached to the substrate 126 or a carrier wafer. In these embodiments, both the substrate and the sensor 122 may be transparent. For example, the substrate 126 may be a transparent material and the sensor 122 may have a sufficiently thin thickness to be substantially transparent.

### Sensor Chip Manufacturing Process

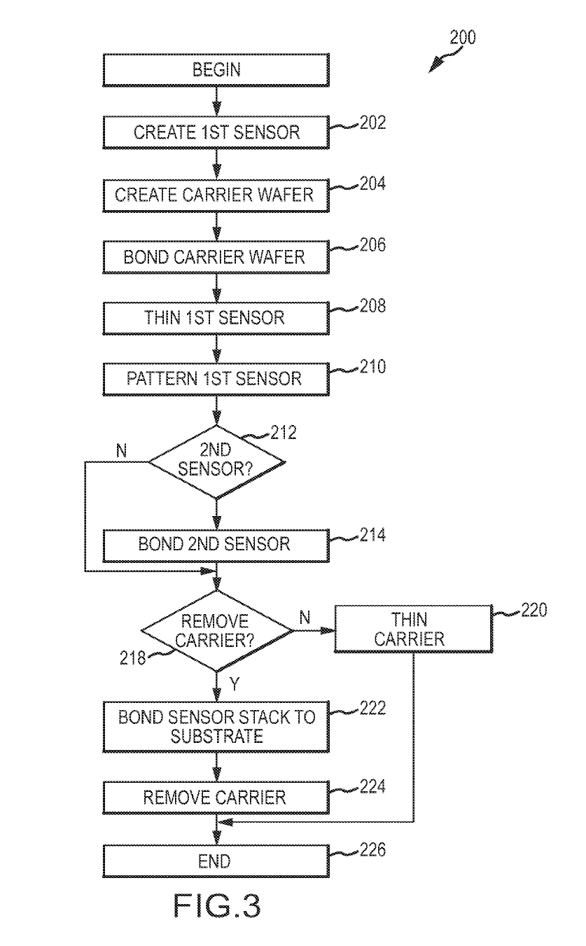

An illustrative method for manufacturing the sensor chip 120 will now be discussed in more detail. FIG. 3 is a flow chart illustrating a method 200 for manufacturing the sensor chip 120. The method 200 may begin with operation 202 and the first sensor 122 may be manufactured. The manufacturing process for the first sensor 122 may depend on the type of data the sensor 122 is going to sense. For example, a wafer including a plurality of capacitive sensing elements may be created by depositing ITO on a wafer substrate. As another example, a silicon wafer may be doped to create one or more photosensitive elements.

In some embodiments, operation 202 may also include passivation. For example, in instances where the first sensor 122 is created on a silicon wafer, a plasma oxide or other passivation material may be applied to the first sensor 122 to reduce the effects of some environmental factors, e.g., reduce the chances of oxidation. Additionally, the first sensor 122 may also be planarized. For example, the wafer may be subjected to a chemical mechanical polishing or planarization to smooth one or more surfaces of the first sensor 120 through one or more chemical or mechanism forces (e.g., chemical etching and/or free abrasive polishing). However, it should be noted that the first sensor 122 may be prepared in a variety of different manners as desired.

Once the first sensor 122 has been formed, the method 200 may proceed to operation 204. In operation 204, the carrier wafer or substrate 126 may be formed. The substrate 126 can be a silicon wafer or other material that can be processed selectively to create silicon dioxide. Additionally, with reference to FIG. 2B, in some instances, one or more alignment marks 130 may be formed on the substrate 126. The substrate 126 may also include an oxide film 134 connected thereto. Similarly to the passivation of the first sensor 122, the oxide film 134 reduces the reactivity of the substrate 126. Depending on the material used for the substrate 126 or the application of the sensor chip 120, the oxide film 134 may be omitted or replaced with another type of protective layer.

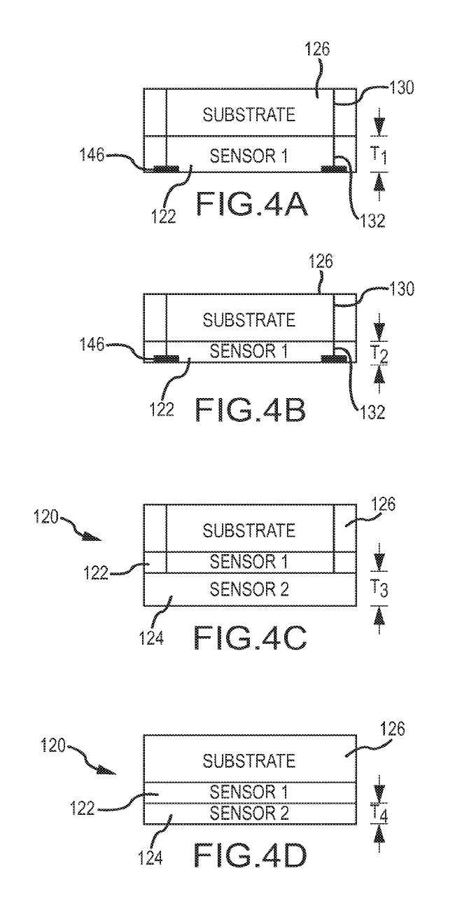

Once the substrate 126 is created, the method 200 may proceed to operation 206. In operation 206 the two wafers may be bonded together. FIG. 4A is a block diagram illustrating the substrate 126 and the first sensor 122 initially being bonded together. With reference to FIG. 4B, the first sensor 122 and the substrate 126 may be aligned using one or more alignment marks 130, 132 and then connected together. Aligning the first sensor 122 and the substrate 126 prior to bonding the two together allows electrical connections, such as TSVs or bond pads to be aligned allowing communication between the first sensor 122 and the substrate 126. The two wafers may be bonded together using a number of different techniques, such as, but not limited to, direct bonding, plasma activated bonding, eutectic bonding, and/or hybrid bonding.

Once the substrate 126 is bonded to the first sensor 122, the method 200 may proceed to operation 208. In operation 208, the first sensor 122 may be thinned. The first sensor 122 may be thinned in a number of different manners, such as, but not limited to, back grinding, polishing, selective etch process such as EPI.

With reference to FIG. 4A, after bonding the first sensor 122 may have a thickness Ti. However, after bonding, with reference to FIG. 4B, the first sensor 122 may have a thickness T2. In some embodiments, the thickness T2 may between a few microns to under one micron. In one specific example, the first sensor 122 may have a sufficiently thin thickness T2 to be transparent in the visible light wavelengths, e.g., one micron or less.

In some embodiments, after operation 208 and the first sensor 122 has been thinned, the method 200 may proceed to operation 210. In operation 210 the first sensor 122 may be patterned. For example, one or more connection apertures or TSVs may be formed through the first sensor 122 such that one or more bond pads 146 (see FIG. 4B) or other electrical connections may be accessed. For example, the first sensor 122 may be patterned through a selecting etching process.

It should be noted that in some embodiments, the first sensor 122 may not need to be patterned in order for the bond pads 146 to be accessed and the bond pads 146 can be accessed from the substrate 126. For example, the bond pads 146 may be formed on the surface of the first sensor 122 positioned against the surface of the substrate 126 and one or more TSVs or other connections may be formed through the substrate 126 to connect the bond ads 146 to other components, such as drivers or other circuitry.

With continued reference to FIG. 3, after operation 210, the method 200 may proceed to operation 212. In operation 212 a user or a computer may determine whether a second sensor should be added to the sensor chip 120. In some instances, the sensor chip 120 may include the first sensor 122 and the substrate 126 and in other instances the sensor chip 120 may include two or more sensors stacked together. The number of sensors may depend on the type and/or number of parameters to be sensed by the sensor chip 120, as well as the desired thickness of the sensor chip 120.

If in operation 212 a second sensor is to be added, the method 200 proceeds to operation 214. With reference to FIGS. 3 and 4C, during operation 216, the second sensor 124 is bonded to the first sensor 122. In one example, the second sensor 124 may be bonded to the exposed face of the first sensor 122, such that the first sensor 122 may be sandwiched between the substrate 126 and the second sensor 124. The second sensor 124 may be bonded to the first sensor 122 using the methods described above with respect to operation 206.

Once the second sensor 124 is bonded to the first sensor 122, the method 200 may proceed to operation 216. In operation 218, the second sensor 124 may be thinned. Operation 216 may be substantially similar to operation 208 and the second sensor 124 may be thinned using the methods and techniques described above with respect to operation 208. With reference to FIG. 4C, when the second sensor 124 is initially bonded to the first sensor 122, the second sensor 124 may have a thickness T3. However, with reference to FIG. 4D, after bonding, the second sensor 124 may have a thickness T4, where the thickness T4 after bonding may be smaller than the thickness T3 before thinning. As described above with respect to the first sensor 122, the after thinning thickness T4 may be sufficiently thin so as to be transparent or substantially transparent.

After operation 216 or if in operation 212 a second sensor is not desired, the method 200 may proceed to operation 218. In operation 218, the user or a computer determines whether the substrate 126 is going to be removed. In some instances, the substrate 126 may function as a carrier wafer and may be used to support the sensor or sensors 122, 124 during manufacturing, but may be removed once both sensors have been connected together. Alternatively, the substrate 126 may include one or more active elements and remain a portion of the sensor chip 120.

If in operation 220 the substrate 126 is not removed, the method 200 proceeds to operation 222. In operation 222 the substrate 126 may be thinned. The substrate 126 may be thinned in substantially the same manner as the first sensor 122 in operation 208. For example, the substrate 126 may be thinned through grinding, polishing, EPI or the like. However, during operation 210, the substrate 126 may be thinned less than the first sensor 122. For example, the substrate 126 may be thinned to a thickness ranging between 100 to 150 microns and in some implementations about 120 microns. In other embodiments, the substrate 126 may be thinned selectively to reach the passivation oxide layer 134. In other words, the substrate 126 may be thinned such that the thickness of the substrate 126 may be slightly larger or the same as the thickness of the passivation oxide layer 134.

Typically, the substrate 126 may remain thicker than the first sensor 122 after operation 208 in order to provide sufficient thickness for the sensor chip 120 to be handled during the remaining processing. However, in instances where the sensor chip 120 may not need to be further handled or where smaller thicknesses are desired, the substrate 126 may be further reduced in thickness.

In some embodiments, the substrate 126 may be thinned and the first sensor 122 may be thicker or maintain its original thickness. Alternatively, the substrate 126 may be thinner than the first sensor 122. For example, the first sensor 122 or device wafer may remain thicker and the substrate 126 (which may also be an active chip) may be thinned. In these embodiments, operation 208 may be omitted or the first sensor 122 may be slightly thinned during operation 208. In embodiments where the substrate 126 may be an active wafer, the substrate 126 may include a plurality of logic and mixed signal circuitry. Additionally, one or more TSVs may connect the components defined on the substrate 126 to the first sensor 122 and/or second sensor 124. As one specific example, the substrate 126 may be connected to the first sensor 122 through TSVs having a pitch of approximately 6 microns. However, many other pitch values and connection techniques are envisioned.

In operation 218 if the substrate 126 is going to be removed, the method 200 may proceed to operation 222. In operation 222, the sensor chip 120 is bonded to another substrate. For example, the new substrate may be a permanent substrate and may form a portion of another component of the electronic device 100. Once the sensor chip 120 is bonded to a final substrate, the method 200 proceeds to operation 224. In operation 224, the carrier substrate 126 may be removed. The substrate 126 may be removed in a number of different manners, such as, but not limited to, applying one or more solvents, etching, grinding, or the like. In some embodiments, operation 224 may be performed at the die stage of the wafer processing and the substrate 126 may be a polymer material that may be removed using one or more solvents. In embodiments where the substrate 126 is removed from the sensor chip 120 (such as shown in FIG. 2A) the substrate 126 may provide structural support during processing and is then removed.

It should be noted that depending on the thicknesses of the first and second sensor 122, 124 that the carrier substrate 126 may be removed prior to the sensor chip 120 being bonded to a secondary or permanent substrate. In these examples, one of the sensors 122, 124 may have an after thinning thickness T2, T4 that may be sufficiently large to allow handling of the sensor chip 120 such that the sensor chip 120 may be transferred and attached to the mounting substrate. Alternatively, a transportation substrate, such as tape or other removable adhesive, may be applied to transport the sensor chip to the mounting substrate.

Once the carrier substrate has been removed in operation 224 or once the substrate 126 has been thinned, the method 200 may proceed to an end state 226.

### Examples of Components Incorporating the Sensor Chip

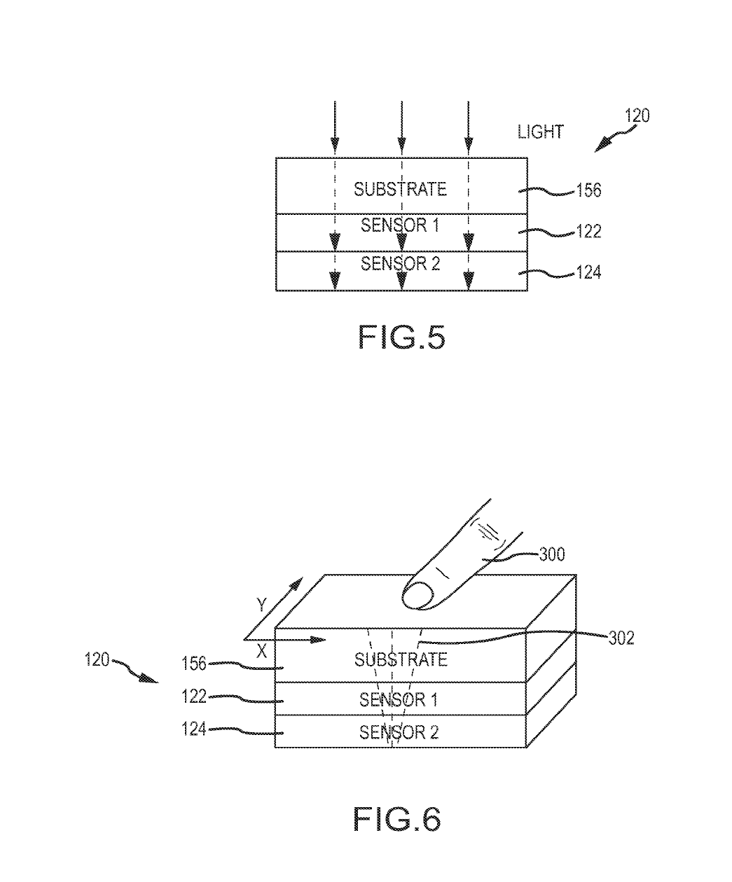

Using the method 200, the sensor chip 120 created may be a very thin layer including sensing elements. With reference again to FIGS. 2A and 2B, the sensor chip 120 created using the method 200 of FIG. 3 may include the two sensors 122, 124 and optionally a substrate 126. As discussed above, the substrate may be a transparent material and allow light to be transmitted therethrough. FIG. 5 is a simplified cross-section view of the sensor chip 120 connected to a transparent substrate taken along line 5-5 in FIG. 1A. With reference to FIG. 5, in some embodiments, the mounting substrate 156 may be transparent or substantially transparent. In these embodiments, the mounting substrate 156 may allow light to be transmitted therethrough and encounter the first sensor 122 and/or the second sensor 124. As some non-limiting examples, the mounting substrate 156 may be glass, crystal, sapphire, or the like. As one example, the mounting substrate 156 may be the cover glass or plastic on the display 104 of the computing device 100.

The mounting substrate 156 is bonded to the sensor chip 120 as described in operation 222 in the method 200 of FIG. 3 or through other mechanisms, such as adhesives or the like. Additionally, as shown in FIG. 5, one or both of the sensors 122, 124 may also be transparent. For example, the first sensor 122 may have a thickness T2 after thinning that may be sufficiently thin so as to allow almost all light wavelengths to be transmitted therethrough. In other words, the material of the first sensor 122 may be sufficiently thin to prevent (or substantially reduce) light from being scattered as the light travels through the material. In these embodiments, light that enters through the transparent substrate 126 may reach the first sensor 122 and/or the second sensor 124, allowing each of the sensors 122, 124 to sense one more data elements corresponding to the light (or lack thereof).

As a specific example, the first sensor 122 may be a capacitive touch sensor and the second sensor 124 may be an image sensor. FIG. 6 is a cross-section of a user providing an input to the sensor chip 120. With reference to FIG. 6, the user may apply an input the substrate 126 with his or her finger 300. Light waves 302 corresponding to the finger 300 (or being blocked by the finger 300) may be transmitted through both the substrate 156 and the first sensor 122 to reach the second sensor 124. Accordingly, the first sensor 122 may capture a capacitive data element corresponding to the finger 300 and the second sensor 124 may capture an image of the finger 300.

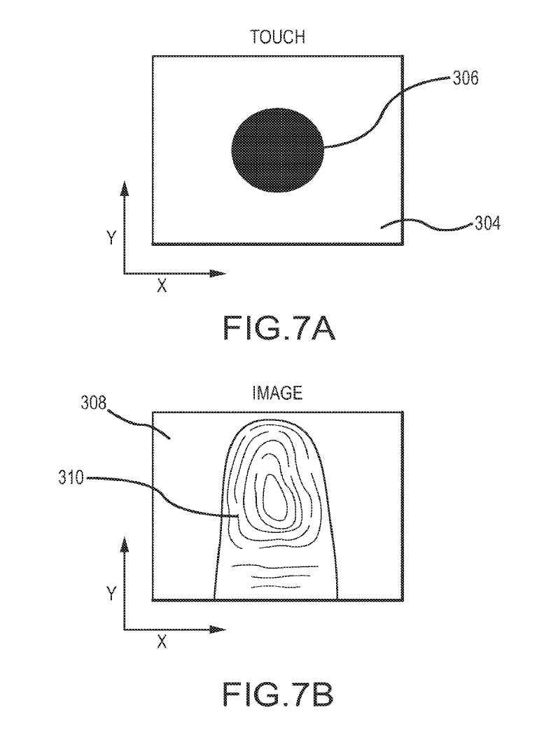

FIG. 7A is a simplified diagram of data captured by the first sensor 122. With reference to FIG. 7A, a touch location 306 may be detected in an image 304 or plane corresponding to the location on the substrate 126 where the user pressed his or her finger 300. In this example, the touch location 306 may correspond to a change in capacitance at the touch location 306 due to the interaction of the finger 300 and the one or more sense elements disposed within the first sensor 122 (e.g., one or more drive and/or sense electrodes).

Because the second sensor 124 is vertically stacked with the first sensor 122, the second sensor 124 may sense data corresponding to the same location in the X-Y plane as the first sensor 122. FIG. 7B is a simplified diagram of data captured by the second sensor 124. With reference to FIG. 7B, the second sensor 124 may capture an image of the finger 300 as the finger 300 applies an input to the substrate 156. The image 308 may include a fingerprint 310 of the finger 300. It should be noted that in FIG. 7B, the image 308 is the fingerprint 310; however, in other embodiments, other images may be captured, such as veins, bone structure, etc.

With reference to FIGS. 6-7B, an input on an X-Y or lateral location on the substrate 156 may be captured by both the first sensor 122 and the second sensor 124. In this manner, the fingerprint 310 and the touch location 306 may correspond to the same input by the user. In other words, the image 308 captured by the second sensor 124 may be directly correlated to the touch data captured by the first sensor 122. This may allow the two sets of data to be correlated together and the capacitive data of the finger 300 as sensed by the first sensor 122 can be used jointly with the related fingerprint image 310 captured by the second sensor 124.

In the above examples illustrated in FIGS. 7A and 7B, the first sensor 122 is a capacitive sensor and the second sensor 124 is an image sensor. However, many other sensors types are envisioned. In a first example, the first sensor 122 may be an optical sensor (such as an optical fingerprint sensor) and the second sensor 124 may be an infrared image sensor. In this example, the two sensors 122, 124 may both sense optical data elements, but with one sensing a first range of light wavelengths (e.g., visible spectrum) and one sensing a second range of light wavelengths (e.g., infrared). In this example, the first and second sensors may be used to sense pulse detection and vein mapping for a single location of the finger 300. This may allow multiple characteristics of the finger 300 at a particular location and instance can be determined simultaneously or substantially simultaneously.

In a second example, the first sensor 122 may be a capacitive or other touch sensing element and the second sensor 124 may be an infrared sensor. As a third example, the first sensor may be a capacitive sensor and the second sensor may be a near field camera. As a fourth example, one of the sensors may be a fingerprint sensor, such as an ultrasonic sensor and the other of the sensors may be a touch sensor or an image sensor. In this example, the sensor chip 120 may be used to detect a fingerprint input, as well as one or more characteristics of the input, such as pulse rate, vein mapping, blood flow, etc., that may be used to enhance the initial sensed input. In some embodiments, the electronic device 100 may use a fingerprint detection as a security feature (e.g., to unlock data or a home screen) or as another type of input and by combining two or more sensors together, the sensor chip 120 may allow the electronic device 100 to gather multiple data points for a single input, that may enhance the processing of the input, as well as increase the security of the fingerprint detection. As a specific example, two users may have similar fingerprints that may be difficult to distinguish without high resolution, but the two users may have much different vein maps through the finger. Thus, by using a fingerprint sensor in combination with an infrared sensor that may detect blood flow or veins, the electronic device 100 can more accurately analyze a fingerprint. The above examples are merely illustrative only and many other sensor combinations and uses are envisioned.

With reference to FIGS. 6-7B, the sensors 122, 124 may be used to detect one or more biometric and/or biological parameters of a user. For example, the first sensor 122 capture data relating to blood flow or heart rate and the second sensor 124 may capture data relating to temperature of the skin, skin color, dryness or moisture level within the skin, etc.

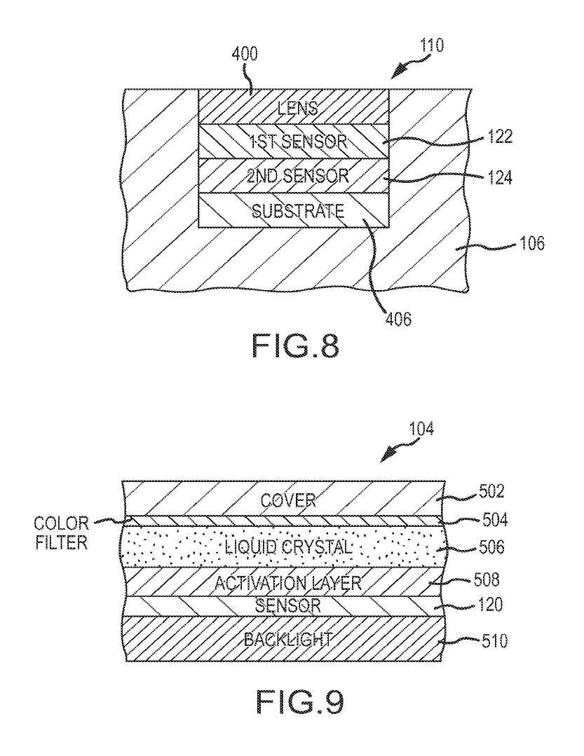

As shown in FIGS. 6-7B, the sensor chip 120 may be included as part of an input button or input surface for the electronic device 100. Specifically, in FIGS. 6-7B the sensor chip 120 may be positioned beneath or as part of the input button 108, which may allow the sensor chip 120 to sense user inputs to the button 108. However in other embodiments, the sensor chip 120 may be incorporated as part of a camera that may sense two types of data simultaneously. FIG. 8 is a cross-section view of the electronic device 100 taken along line 8-8 in FIG. 1A. With reference to FIG. 8, in this embodiment, the sensor chip 120 may be included as part of the camera 110 of the electronic device 100.

In this embodiment, a lens 400 of the camera may act as the mounting substrate for the sensor chip 120. The lens 400 may be a substantially transparent or clear material (such as glass, plastic, or the like) that may transmit light wavelengths therethrough. The first sensor 122 and the second sensor 124 may be vertically aligned with the lens 400 such that both sensors 122, 124 may receive light as it is transmitted through the lens 400. In these embodiments, at least the first sensor 122 may be transparent or partially transparent to allow light to reach the second sensor 124 stacked below. Optionally, the sensor chip 120 may be further stacked on a support substrate 402. The support substrate 402 may be active wafer and include electrical components, such as transistors or other gates that may selectively transmit light data from the sensors 122, 124 and/or may activate the sensors 122, 124.

The camera 110 including the sensor chip 120 may be mounted or otherwise connected to the electronic device 100 through the enclosure 106. For example, with reference to FIGS. 1A and 8, the enclosure 106 may at least partially surround the camera 110 and secure the components to the device 100.

In the embodiment illustrated in FIG. 8, the first sensor 122 may be an image or optical sensor including a color filter and the second sensor 124 may be a monochrome image sensor. Data from the two sensors may be combined to enhance resolution of images captured by the camera 110, introduce one or more effects into the images, or the like. In another embodiment, the first sensor 122 may be an infrared sensor and the second sensor 124 may be an optical sensor. In this manner, data relating to both the visible and non-visible wavelengths may be captured by the camera 110. In other examples, one sensor may be used to gather one or more biometric or biological properties where the other sensor may be an image sensor. For example, the first sensor 122 may be an image sensor and the second 124 may be an image sensor configured to perform retinal scans. In this example, the user may use the camera 110 to capture pictures, as well as to verify a user identity or otherwise use data correlated to the retinal scan.

In some embodiments, the sensor chip 120 may be connected to the display 104 of the electronic computing device 100. FIG. 9 is a simplified cross-section of the electronic device taken along line 9-9 in FIG. 1A. In this embodiment, the sensor chip 120 forms a part of the display 104 for the electronic device. This may allow the display 104 to sense touch inputs by a user (e.g., capacitive multi-touch inputs) along with other types of data inputs (e.g., optical resistive, ultrasonic, etc.). For example, the display 104 may provide a visual output to a user and with the sensor chip 120 may also provide an input component for the user.

With reference to FIG. 9, in a specific example, the display 104 may include a liquid crystal layer 506 bounded by a cover 502, color filter 504 and an activation layer 506. The cover 502 may be a substantially transparent material to allow light transmitted through the liquid crystal layer 506 to reach a user and may be glass, plastic, or the like. The color filter 504 may be a Bayer pattern or other pattern and may filter one or more light wavelengths to determine the color of one or more pixels. The activation layer 508 may include one or more switches or gates, such as thin-film transistors (TFTs) that may be used to selectively activate the liquid crystal layer 506. In some embodiments, the switches or gates in the activation layer 508 may be deposited on a glass or other substantially clear substrate. A back light 510 may be positioned beneath the liquid crystal layer 506 and provides a light source to illuminate the liquid crystal layer 506.

In the embodiment illustrated in FIG. 9, the sensor chip 120 may be mounted between the activation layer 508 and the backlight 510. However, in other embodiments, the sensor chip 120 may be mounted in other areas of the display 104, such as between the cover 502 and the color filter 504.

In the embodiment illustrated in FIG. 9, because the sensor chip 120 may be transparent or substantially transparent, light may be transmitted from the backlight 510 to the liquid crystal layer 506. The liquid crystal 506 layer may then selectively transmit light therethrough based on the activation layer 508.

The sensor chip 120 and the sensors 122, 124 can be configured to detect two separate types of inputs applied to the display 104 and/or enhance resolution of inputs applied to the display 104. As an example, the first sensor 122 may detect capacitance or touch inputs and the second sensor 124 (when included) may detect optical properties.

### CONCLUSION

The foregoing description has broad application. For example, while examples disclosed herein may focus on a certain sensor types, it should be appreciated that the concepts disclosed herein may equally apply to many other types of sensors or data sensing elements. As another example, although the substrate has been discussed as being transparent, in other embodiments, the substrate may not be transparent or may be partially transparent. Similarly, although the process and sensor chip are discussed with respect to a substrate, the sensor chip 120 may be a stack including one or two sensors and the substrates may be removed after manufacturing. Accordingly, the discussion of any embodiment is meant only to be exemplary and is not intended to suggest that the scope of the disclosure, including the claims, is limited to these examples.

We claim:

1. An electronic device comprising:
a processor; and
a sensing element in communication with the processor, the sensing element comprising a first sensor and a second sensor vertically aligned, wherein at least one of the first sensor or the second sensor is transparent.

2. The electronic device of claim 1, wherein the first sensor is a capacitive sensor and the second sensor is an optical sensor.

3. The electronic device of claim 1, further comprising
a display in communication with the processor, the display comprising:
a cover; and
a visual output element; wherein
the sensing element is connected to the cover.

4. The electronic device of claim 1, further comprising an input button and the sensing element is configured to detect a first parameter and a second parameter corresponding to a user input to the input button.

5. The electronic device of claim 4, wherein the first parameter is a touch input and the second parameter is a biometric input.

6. The electronic device of claim 5, wherein the touch input is a capacitance value and the biometric input is a fingerprint.

7. The electronic device of claim 1, wherein the sensing element detects infrared light wavelengths and visible light wavelengths.

8. The electronic device of claim 1, wherein both the first sensor and the second sensor are transparent.

9. The electronic device of claim 1, wherein the sensing element further comprises a substrate, wherein the substrate is transparent.

10. The electronic device of claim 9, wherein the substrate is a lens.

11. A method for creating a sensor chip comprising:
creating a first sensor configured to sense a first parameter, the first sensor having a first original thickness;
bonding a carrier wafer to a first side of the first sensor;
reducing the first original thickness of the first sensor to a first thinned thickness; and
bonding a second sensor configured to sense a second parameter to the first sensor, the second sensor having a second original thickness.

12. The method of claim 11, further comprising reducing the second original thickness of the second sensor to a second thinned thickness.

13. The method of claim 11, further comprising removing the carrier wafer from the first sensor.

14. The method of claim 11, wherein the first parameter is different from the second parameter.

15. The method of claim 14, wherein the first parameter is a capacitance value and the second parameter is an optical characteristic.

16. The method of claim 11, wherein the first thinned thickness is between 2 to 0.5 microns.

17. The method of claim 11, wherein the first thinned thickness is sufficiently thin to allow light to be transmitted through the first sensor.

18. A method for creating a sensing element for a computing device comprising:
creating a transparent sensor chip configured to detect two types of parameters; and
attaching the transparent sensor chip to a substrate.

19. The method of claim 18, wherein the operation of creating the transparent sensor chip comprises:
creating a first sensor configured to sense a first parameter, the first sensor having a first original thickness;
bonding a carrier wafer to a first side of the first sensor;
reducing the first original thickness of the first sensor to a first thinned thickness; and
bonding a second sensor configured to sense a second parameter to the first sensor, the second sensor having a second original thickness.

20. The method of claim 19, wherein the substrate is transparent.
